(19) United States
(12) Patent Application Publication
(10) Pub. No.: US 2019/0023819 A1
(43) Pub. Date: Jan. 24, 2019

(54) Conductive Ultrahigh Molecular Weight Polyethylene Compositions

(71) Applicant: Celanese Sales Germany GmbH, Sulzbach (DE)

(72) Inventors: Christina Schmid, Darmstadt (DE); Rainer Walkenhorst, Melle (DE)

(21) Appl. No.: 16/040,794

(22) Filed: Jul. 20, 2018

Related U.S. Application Data
(60) Provisional application No. 62/535,614, filed on Jul. 21, 2017.

(51) Int. Cl. C08F 10/02; C09K 5/14; C08K 3/38; C08K 3/04; B65G 21/20; H01B 1/24

(52) U.S. Cl. CPC C08F 10/02; C09K 5/14; C08K 3/38; C08K 3/04; C08K 2003/385; H01B 1/24; C08K 2201/001; C08K 2201/005; B65G 21/2072

(57) ABSTRACT

Thermally or electrically conductive high molecular weight polyethylene compositions are disclosed. The polymer compositions can contain thermally conductive particulate material, such as boron nitride. Alternatively or in addition, the polymer composition may contain a thermally and electrically conductive material, such as an ionic liquid or graphite particles.

### RELATED APPLICATIONS

The present application is based on and claims priority to U.S. Provisional Application Ser. No. 62/535,614, having a filing date of Jul. 21, 2017, which is incorporated herein by reference in its entirety.

### BACKGROUND

Polyethylene has become established as an exceptionally useful engineering material in a variety of applications, in part because of its unique combination of desirable properties. For instance, polyethylene polymer particles may exhibit an improved abrasion resistance, chemical resistance, lubricity, impact strength, stress crack resistance, heat deflection temperature, wear resistance, and energy absorption capacity at high stress rates in comparison to other thermoplastic polymers.

Consequently, polyethylene polymers have been utilized in a variety of applications. For instance, these polymers have been utilized in the textiles industry, food industry, packaging industry, paper industry, mechanical industry, etc. In particular, polyethylene polymers have been found to be excellent materials for sliding applications especially when compared with other thermoplastic materials, partly due to the self-lubricating properties of the polyethylene polymers. These sliding applications may include applications where a polymer article comprising the polyethylene polymer is in moving contact with other counter-materials, such as those comprising metals, plastics, brass, copper, and the like.

However, with some current polyethylene compositions, the polyethylene article and/or the counter-material exhibit substantial wear when in moving contact at high velocity. This is often caused by the heat created from friction between the polyethylene and the counter material in high velocity sliding applications. In some instances, the article and/or counter material may even exhibit melting.

Although polyethylene polymer compositions have been modified in the past, further improvements are still necessary. In particular, a need exists for providing a composition and a polymer article produced therefrom with improved thermal conductivity in order to dissipate heat from the sliding interface when in moving contact with a counter material, thus reducing the temperature and preventing melting and degradation of the article and/or the counter-material.

### SUMMARY

In general, the present disclosure is directed to polyethylene compositions comprising polyethylene polymer particles and at least one conductive material, and articles made therefrom. In one aspect, the conductive material may be any suitable thermally conductive filler which increases the thermal conductivity of the composition compared to that of the polyethylene composition without the thermally conductive filler. In another aspect, the conductive material may be any electrically conductive compound that better resists the build-up of static charge on a surface compared to that of the polyethylene composition without the conductive material.

In one embodiment, for instance, the present disclosure is directed to a conductive polymer composition. The polymer composition contains an polyethylene polymer blended with a conductive material. In one embodiment, for instance, the polyethylene polymer is blended with at least one thermally conductive filler. The conductive filler can be present in the polymer composition in an amount sufficient for the polymer composition to have an in-plane thermal conductivity of about 1 W/m-K or greater, such as about 2.3 W/m-K or greater. In one embodiment, for instance, the conductive filler can be present in the polymer composition sufficient for the polymer composition to have an in-plane thermal conductivity of about 2.3 W/m-K or greater in a first direction (i.e. such as a flow direction) and in a second direction that is perpendicular to the first direction.

In various embodiments, the at least one conductive filler can be present in the polymer composition sufficient for the polymer composition to have an in-plane thermal conductivity of greater than about 1 W/m-K, such as greater than about 2.5 W/m-K, such as greater than about 3 W/m-K, such as greater than about 3.5 W/m-K, such as greater than about 4 W/m-K, such as greater than about 4.5 W/m-K, such as greater than about 5 W/m-K, such as greater than about 5.5 W/m-K, such as greater than about 6 W/m-K, such as even greater than about 6.5 W/m-K. The in-plane thermal conductivity is generally less than about 50 W/m-K. The amount of conductive filler present in the composition can depend upon various factors and the desired result. In general, the at least one conductive filler is present in the polymer composition in an amount greater than about 10% by weight, such as in an amount from about 20% to about 40% by weight. The conductive filler, for instance, may comprise boron nitride, graphite, or mixtures thereof.

In one embodiment, the conductive filler is in the form of particles. The particles, for instance, can have an average particle size (d50) of from about 0.5 microns to about 100 microns. The average particle size, for instance, can be greater than about 2 microns, such as greater than about 5 microns, such as greater than about 7 microns, such as greater than about 10 microns, such as greater than about 12 microns and generally less than about 30 microns, such as less than about 25 microns, such as less than about 20 microns, such as less than about 15 microns.

In one embodiment, a particular type of polyethylene polymer may be selected for enhancing the thermal conductivity characteristics of the resulting composition. For example, in one embodiment, the polyethylene polymer may have a relatively low bulk density. The bulk density of the polymer, for instance, can be less than about 0.3 g/cm³, such as less than about 0.28 g/cm³, such as less than about 0.26 g/cm³, such as less than about 0.25 g/cm³, such as less than about 0.23 g/cm³, such as less than about 0.20 g/cm³. Although having a relatively low bulk density, the polyethylene can have a relatively high molecular weight. For instance, the molecular weight can be greater than about 100,000 g/mol, such as greater than about 1,000,000 g/mol, such as greater than about 3,800,000 g/mol, such as greater than about 4,000,000 g/mol when calculated using Margolies equation.

Various different polymer articles can be formed from the polymer composition. The polymer articles can be formed through a molding process and/or a sintering process. In one embodiment, the polymer composition can be used to produce a wear strip or guide rail. The wear strip or guide rail, for instance, can be configured such that an opposing member slides along or against the polymer article made in accordance with the present disclosure. Due to the thermal conductivity properties, the polymer article made in accordance with the present disclosure can be used in sliding applications and can efficiently dissipate heat that may be created due to frictional forces.

In an alternative embodiment of the present disclosure, the polyethylene polymer is combined with an electrically conductive material, such as an ionic liquid. The ionic liquid can be present in the polymer composition in an amount from about 1% to about 15% by weight, such as in an amount from about 3% to about 7% by weight. In one embodiment, the polymer composition can contain an ionic liquid in combination with a conductive filler. The conductive filler, for instance, may comprise boron nitride, graphite, or mixtures thereof.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a conveyor system that may include molded articles made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polyethylene composition comprising polyethylene polymer particles and at least one conductive material, and articles made therefrom. In one embodiment, the polyethylene polymer particles are made from a relatively high molecular weight polyethylene. In a further embodiment, the high molecular weight polyethylene is an ultrahigh molecular weight polyethylene (having a molecular weight of greater than about 3,000,000 g/mol). In one aspect, the conductive material may be any suitable thermally conductive filler which increases the thermal conductivity of the composition compared to that of the polyethylene composition without the thermally conductive filler. In another aspect, the conductive material may be any electrically conductive compound that dissipates static charge on a surface compared to that of the polyethylene composition without the conductive material.

In one embodiment, when the polymer composition contains thermally conductive particles, the composition can have excellent heat dissipation properties. For example, the polyethylene composition can help prevent melting of a counter-material in moving contact with an article formed from the polyethylene composition in sliding applications. It is believed that the thermally conductive composition allows heat to be dissipated from the contact surface of the article, thus reducing the temperature and/or preventing temperature increases at the interface between the article and the counter material. This reduction of temperature lessens the chance that the counter material will melt.

Alternatively, or in addition to increasing the thermal conductivity of the article, in another embodiment, the polymer composition of the present disclosure can include an electrically conductive material. For example, in one embodiment, an electrically conductive material, such as an ionic liquid or graphite, can be incorporated into the polymer composition containing the polyethylene polymer. The electrically conductive material prevents the build-up of static charges.

According to the present disclosure, the polymer composition is comprised of a polyethylene, such as a high molecular weight polyethylene. The polyethylene may be a homopolymer, a copolymer, or a blend thereof. In one embodiment, the polyethylene may be a homopolymer. For instance, in one embodiment, the polyethylene is a homopolymer of ethylene.

In another embodiment, the polyethylene may be a copolymer. For instance, the polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene. However, when present, the amount of the non-ethylene monomer(s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the polyethylene may exhibit a bimodal molecular weight distribution. For instance, a bimodal distribution generally refers to a polymer having a distinct higher molecular weight and a distinct lower molecular weight (e.g. two distinct peaks) on a gel permeation chromatography curve. In another embodiment, the polyethylene may exhibit more than two molecular weight distribution peaks such that the polyethylene exhibits a multimodal (e.g., trimodal, tetramodal, etc.) distribution. Alternatively, the polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

In one embodiment, the composition may be comprised of more than one polyethylene polymer, each having a different molecular weight and/or molecular weight distribution. For instance, the molecular weight distribution may be within the average molecular weight specifications provided above.

In addition, the composition may be comprised of a blend of one or more polyethylene polymers or copolymers and another thermoplastic polymer such as a polypropylene or a polybutylene. However, the amount of non-polyethylene polymer(s) in the composition may be less than about 10 wt. %, such as less than about 5 wt. %, such as less than about 2.5 wt, %, such as less than about 1 wt. %, wherein the wt % is based on the total weight of the composition.

Any method known in the art can be utilized to synthesize the polyethylene. The high molecular weight polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natty type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-magnesium and zinc stearate.

Optionally, other catalysts such as Phillips catalysts, metallocenes and post metallocenes may be employed. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing high molecular weight polyethylene. Other suitable catalyst systems include Group 4 metal complexes of phenolate ether ligands such as are described in International Patent Publication No. WO2012/004675, the entire contents of which are incorporated herein by reference.

In one embodiment, the polyethylene polymer selected for use in the polymer composition has a relatively high molecular weight in relation to the bulk density of the polymer. It is believed that using a polyethylene polymer with the above characteristics further enhances the conductivity properties of the composition when combined with a conductive material.

As used herein, a polyethylene may have an average molecular weight, as determined according to Margolies equation, of at least or greater than 100,000 g/mol, such as at least about 500,000 g/mol, such as at least about 1,000,000 g/mol, such as at least about 2,000,000 g/mol, such as at least about 3,000,000 g/mol, such as at least about 3,200,000 g/mol, such as at least about 3,400,000 g/mol, such as greater than about 3,600,000 g/mol, such as greater than about 3,800,000 g/mol, such as greater than about 4,000,000 and generally less than about 20,000,000 g/mol, such as less than about 15,000,000 g/mol, such as less than about 12,000,000 g/mol, such as less than about 10,000,000 g/mol, such as less than about 7,500,000 g/mol, such as less than about 6,000,000 g/mol.

In addition to having a relatively high molecular weight, the polyethylene polymer can also have a relatively low bulk density as measured according to DIN53466. For instance, in one embodiment, the bulk density is generally less than about 0.4 g/cm³, such as less than about 0.37 g/cm³, such as less than about 0.35 g/cm³, such as less than about 0.33 g/cm³, such as less than about 0.3 g/cm³, such as less than about 0.27 g/cm³, such as less than about 0.25 g/cm³, such as less than about 0.23 g/cm³, such as less than about 0.20 g/cm³. The bulk density is generally greater than about 0.1 g/cm³. In one embodiment, the polymer has a bulk density of from about 0.2 g/cm³ to about 0.27 g/cm³.

The polyethylene may be manufactured in the form of a powder such as a micropowder. For instance, the polyethylene power may be a free-flowing powder. Preferably, the polyethylene powder has a multi-lobal (popcorn-like) morphology. The powder may have an average particle size, d50, of no more than 2,000 μm, such as between about 10 and about 1,500 μm, such as from about 50 μm to about 650 μm, such as from about 50 to about 400 μm, such as from about 50 to about 200 μm. Preferably, the as-synthesized polymer has the desired particle size. However, if the as-synthesized polymer has a particle size in excess of the desired value, the particles can be ground to the desired particle size. The powder particle size can be measured utilizing a laser diffraction method according to ISO 13320.

The polyethylene may have a viscosity number of from at least 100 mL/g, such as at least 500 mL/g, such as at least 1,500 mL/g, such as at least 2,000 mL/g, such as at least 4,000 mL/g to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The polyethylene may have a crystallinity of from at least about 40% to 85%, such as from 45% to 80%. In one embodiment, the polyethylene particles can have an anisotropic structure so that heat can be dissipated in a desired direction.

The polyethylene may be present in the composition in an amount of greater than about 40 wt, %, such as greater than about 50 wt. %, such as greater than about 55 wt. %, such as greater than about 60 wt, %, such as greater than about 65 wt. %, such as greater than about 70 wt. %, such as greater than about 75 wt. % and less than about 90 wt. %, such as less than about 85 wt. %, such as less than about 80 wt. %.

As described, the polyethylene composition contains at least one conductive filler. In one embodiment, the conductive filler is a thermally conductive particulate material.

The thermally conductive particulate material employed in the polymer composition typically has an average size (e.g., diameter) of about 1 to about 100 micrometers, in some embodiments from about 3 to about 50 micrometers, in some embodiments from about 5 to about 30 micrometers, and in some embodiments, from about 7 to about 15 micrometers, such as determined using laser diffraction techniques in accordance with ISO 13320:2009 (e.g., with a Horiba LA-960 particle size distribution analyzer). In one embodiment, relatively smaller particles are used and combined with the polyethylene polymer. For instance, the particles can have an average particle size of less than about 20 micrometers, such as less than about 15 micrometers and generally greater than about 0.5 micrometers, such as greater than about 1 micrometer, such as greater than about 5 micrometers.

The thermally conductive particulate material may also have a narrow size distribution. That is, at least about 70% by volume of the particles, in some embodiments at least about 80% by volume of the particles, and in some embodiments, at least about 90% by volume of the particles may have a size within the ranges noted above. The specific surface area of the material may also be relatively high, such as about 0.5 m²/g or more, in some embodiments about 1 m²/g or more, and in some embodiments, from about 2 to about 40 m²/g. The specific surface area can be determined according to standard methods such as by the physical gas adsorption method (B.E.T. method) with nitrogen as the adsorption gas, as is generally known in the art and described by Brunauer, Emmet, and Teller (J. Amer. Chem. Soc., vol. 60, February, 1938, pp. 309-319). In one embodiment, the particles can have a surface area of from about 3 m²/g to about 8 m²/g.

The particulate material may also have a powder tap density of from about 0.2 to about 1.0 g/cm³, in some embodiments from about 0.3 to about 0.9 g/cm³, and in some embodiments, from about 0.4 to about 0.8 g/cm³, such as determined in accordance with ASTM B527-15.

Further, the thermally conductive particulate material may have a high intrinsic thermal conductivity, such as about 30 W/m-k or more, in some embodiments about 50 W/m-K or more, in some embodiments about 100 W/m-K or more, and in some embodiments, about 150 W/m-K or more. Examples of such materials may include, for instance, boron nitride (BN), aluminum nitride (AlN), magnesium silicon nitride (MgSiN2), graphite (e.g., expanded graphite), silicon carbide (SiC), carbon nanotubes, carbon black, metal oxides (e.g., zinc oxide, magnesium oxide, beryllium oxide, zirconium oxide, yttrium oxide, etc.), metallic powders (e.g., aluminum, copper, bronze, brass, etc.), etc., as well as combinations thereof. In some embodiments, the particulate material, such as graphites and ionic liquids, may exhibit both thermal and electrical conductivity. Boron nitride and graphite are particularly suitable for use in the polymer composition of the present disclosure. In fact, in certain embodiments, boron nitride may constitute a majority of the thermally conductive particulate material employed in the polymer composition, such as about 50 wt. % or more, in some embodiments, about 70 wt. % or more, and in some embodiments, from about 90 wt. % to 100 wt. % of the thermally conductive particulate material. When employed, boron nitride is typically used in its hexagonal form to enhance stability and softness. In other embodiments, graphite may constitute the majority of thermally conductive particles employed in the composition.

In certain embodiments, the thermally conductive particulate material may be in the form of individual platelets having the desired size. Nevertheless, agglomerates of the thermally conductive material having the desired average size noted above may achieve a polymer composition having better properties. Such agglomerates generally contain individual particles that are aggregated together with no particular orientation or in a highly ordered fashion, for instance via weak chemical bonds such as Van der Waals forces. Examples of suitable hexagonal boron nitride agglomerates, for instance, include those commercially under the designations UHP-2 (Showa Denko) and PT-100 (Momentive Performance Materials).

The thermally conductive particulate material is typically employed in the polymer composition in an amount of from about 5 wt. % to about 50 wt. %, in some embodiments from about 10 wt. % to about 45 wt. %, and in some embodiments, from about 20 wt. % to about 40 wt. % based on the total weight of the polymer composition. In general, the thermal conductivity of the composition tends to increase with increased loading of conductive particles. When the amount of thermally conductive particles is below 5 wt. % of the composition, the thermal conductivity is too low. On the other hand, when the amount of thermally conductive particles exceeds 50%, the mechanical properties of the composition are negatively affected.

Alternatively, or in addition to thermally conductive particles, the polyethylene composition may include an electrically conductive material. For instance, the composition may include electrically conductive particles or an ionic liquid.

Any of a variety of electrically conductive fillers may generally be employed in the polymer composition to help improve its antistatic characteristics. Examples of suitable electrically conductive fillers may include, for instance, metal particles (e.g., aluminum flakes), metal fibers, carbon particles (e.g., graphite, expanded graphite, grapheme, carbon black, graphitized carbon black, etc.), carbon nanotubes, carbon fibers, and so forth. Any of the above electrically conductive fillers may be present in the composition in an amount from about 3% to about 30% by weight, such as from about 5% to about 15% by weight.

Another suitable electrically and thermally conductive material is an ionic liquid. Ionic liquids provide electrical connectivity throughout the composition, enhancing the ability of the composition to rapidly dissipate static electric charges from its surface.

The ionic liquid is generally a salt that has a low enough melting temperature so that it can be in the form of a liquid when the polyethylene composition is compression molded, sintered, or extruded. The melting temperature of the ionic liquid may be about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, quaternary oniums having the following structures:

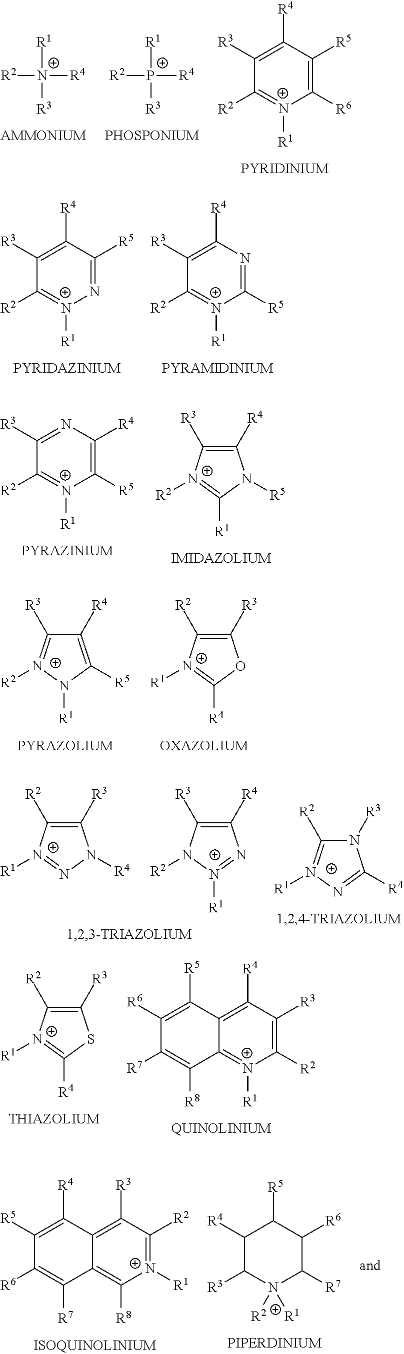

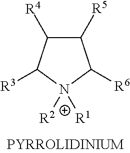

wherein, R1, R2, R3, R4, R5, R6, R7, and R8 are independently selected from the group consisting of hydrogen; substituted or unsubstituted C1-C10 alkyl groups (e.g., methyl, ethyl, n-propyl, isopropyl, n-butyl, isobutyl, sec-butyl, tert-butyl, n-pentyl, etc.); substituted or unsubstituted C3-C14 cycloalkyl groups (e.g., adamantyl, cyclopropyl, cyclobutyl, cyclopentyl, cyclooctyl, cyclohexenyl, etc.); substituted or unsubstituted C1-C10 alkenyl groups (e.g., ethylene, propylene, 2-methypropylene, pentylene, etc.); substituted or unsubstituted C2-C10 alkynyl groups (e.g., ethynyl, propynyl, etc.); substituted or unsubstituted C1-C10 alkoxy groups (e.g., methoxy, ethoxy, n-propoxy, isopropoxy, n-butoxy, t-butoxy, sec-butoxy, n-pentoxy, etc.); substituted or unsubstituted acyloxy groups (e.g., methacryloxy, methacryloxyethyl, etc.); substituted or unsubstituted aryl groups (e.g., phenyl); substituted or unsubstituted heteroaryl groups (e.g., pyridyl, furanyl, thienyl, thiazolyl, isothiazolyl, triazolyl, imidazolyl, isoxazolyl, pyrrolyl, pyrazolyl, pyridazinyl, pyrimidinyl, quinolyl, etc.); and so forth. In one particular embodiment, for example, the cationic species may be an ammonium compound having the structure N+R1R2R3R4, wherein R1, R2, and/or R3 are independently a C1-C6 alkyl (e.g., methyl, ethyl, butyl, etc.) and R4 is hydrogen or a C1-C4 alkyl group (e.g., methyl or ethyl). For example, the cationic component may be tri-butylmethylammonium, wherein R1, R2, and R3 are butyl and R4 is methyl.

Suitable counterions for the cationic species may include, for example, halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. One particularly preferred ionic liquid for incorporation into the polyethylene composition and article is 1-Ethyl-3-methylimiciazolium chloride.

An ionic liquid can generally be present in the polymer composition in an amount greater than about 1% by weight, such as in an amount greater than about 3% by weight, such as in an amount greater than about 4% by weight. The ionic liquid is generally present in an amount less than about 28% by weight, such as in an amount less than about 15% by weight, such as in an amount less than about 10% by weight, such as in an amount less than about 7% by weight.

The polymer composition and polymer article produced therefrom may also contain other known additives such as, for example, antioxidants, UV stabilizers, light stabilizers, heat stabilizers, reinforcing fibers or fillers, lubricants, optical brighteners, colorants, demolding agents, crosslinking agents, plasticizers, pigments, antistatic agents, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, greases, molybdenum disulfide, or any combination thereof.

In one embodiment, a colorant may be present in the composition. The colorant may include, but is not limited to, inorganic and organic based color pigments.

These additives may be used singly or in any combination thereof. In general, unless stated otherwise, if the additives are utilized, they may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt, %, such as less than about 2 wt. %. The sum of the wt. % of all of the components, including any additives if present, utilized in the polymer composition will be 100 wt. %.

The compositions of the present disclosure can be compounded and formed into a mold or a polymer article using any technique known in the art. For instance, the composition can be intensively mixed to form a substantially homogeneous blend. The components can be mixed utilizing a blender such as a high speed blender or a tumble blender, high speed mixer, pelletizer, extruder, or any other method well known in the art. The article can be formed also utilizing compression molding, ram extrusion or sintering into a desired shape utilizing conventional techniques. For instance, compression molding may be conducted according to the procedure described in EP 0613923.

For instance, the components can be mixed and heated to a temperature of from about 180 to 250° C. The components may be heated and/or sintered under a pressure of from about 2 to 6 MPa, such as 3 to 5 MPa. Thereafter, the product or composition is then cooled. The cooling may also be conducted under a pressure of from about 7 to about 10 MPa. Generally, the sintering time and cooling time may depend on the thickness of the composition or article.

The composition can be utilized to provide articles for a variety of applications, in particular wherein low wear and excellent mechanical properties are desired. For instance, the composition can be used to provide articles for the mechanical, food, packaging, bottling, chemical, electroplating, ceramics, paper and pulp, electrical, refrigeration, and cryogenic industries.

For instance, the composition may be utilized for to produce any of the following or components for any of the following: profiles for chain/belt drives, curved guide elements, chain reversers, tensioners, profiles for chain racks, slide rails for conveyor systems, wear strips and guides for conveyor systems, rail track disks, impact absorbing elements, bunker and silo linings, fenders, chutes, rail wagons, ships' holds, platforms/dump trucks, suction boxes and screen covers, doctor blades, sealing strips, stripping elements, foils, filter plates, centrifugal pumps, diaphragm pumps, metering pumps, eccentric pumps, butterfly valves, ball valves, slide valves, seals and gaskets, electroplating drums, bearing systems, gearwheels, bellows, bearing bushes, slide and guide rollers, nozzle, stripping elements, connectors, cable clamps, contact breakers and insulating components for current collectors in subways, dynamic seals, sleeves, piston rings, pump packings, skis and snowboards, ice skating rinks, bowling alleys, sliding and functional parts in seatbelt retractor systems, windscreen wiper drives and control rods, windscreen wiper bearings, mirror adjustors, conveyor chains, toothed racks and gearwheels, adjustment mechanisms, sliding bearing blocks, rollers and wear strips, gearwheels in processes/mixers, rollers, and slicers, door hinges, etc.

The polyethylene polymer composition and polymer article produced therefrom may exhibit improved thermal conductivity and heat dissipation in comparison to unmodified polyethylene and other thermoplastic compositions. Alternatively or additionally, the polyethylene composition and polymer article produced therefrom may exhibit improved antistatic properties compared to unmodified polyethylene compositions.

For example, when tested according to ASTM Test E 1461-13, the polymer composition of the present disclosure can have an in-plane thermal conductivity (in a first direction) of greater than about 2.3 W/m-K, such as greater than about 2.5 W/m-K, such as greater than about 3 W/m-K, such as greater than about 3.5 W/M-K, such as greater than about 4 W/m-K, such as greater than about 4.5 W/m-K, such as greater than about 5 W/m-K, such as greater than about 5.5 W/m-K, such as greater than about 6 W/m-K, such as greater than about 6.5 W/m-K. The in-plane thermal conductivity is generally less than about 50 W/m-K, such as less than about 40 W/m-K. Of particular advantage, polymer articles can be made in accordance with the present disclosure in which the above in-plane thermal conductivity characteristics can exist not only in the first direction but also in a perpendicular second direction. When a part is extruded, for instance, the first direction may comprise the flow direction while the second direction may comprise the cross-flow direction.

In addition to in-plane thermal conductivity, polymer compositions made according to the present disclosure can also have excellent through-plane thermal conductivity characteristics. For instance, the polymer composition can have a through-plane thermal conductivity of greater than about 1.35 W/m-K, such as greater than about 1.4 W/m-K, such as greater than about 1.6 W/m-K, such as greater than about 1.8 W/m-K, such as greater than about 1.9 W/m-K. The through-plane thermal conductivity is generally less than about 5 W/m-K.

Generally, when incorporated into a sliding member or a track, higher sliding speeds may affect the appearance of the components. For instance, at higher speeds in comparison to lower speeds, unmodified polyethylene may become worn while the counter material may melt. For instance, as an example, utilizing a ball-on-prism configuration, a ball may be comprised of unmodified polyoxymethylene while the plate may be comprised of a polyethylene composition. When utilizing an unmodified polyethylene, at higher speeds such as about 1,000 mm/s, the ball may partially melt or even fully melt while the plate may exhibit wear. However, upon modifying the polyethylene with a conductive filler as described herein, the ball may exhibit minimal wear or melting or even no wear or melting, while the plate may also exhibit minimal or even no wear.

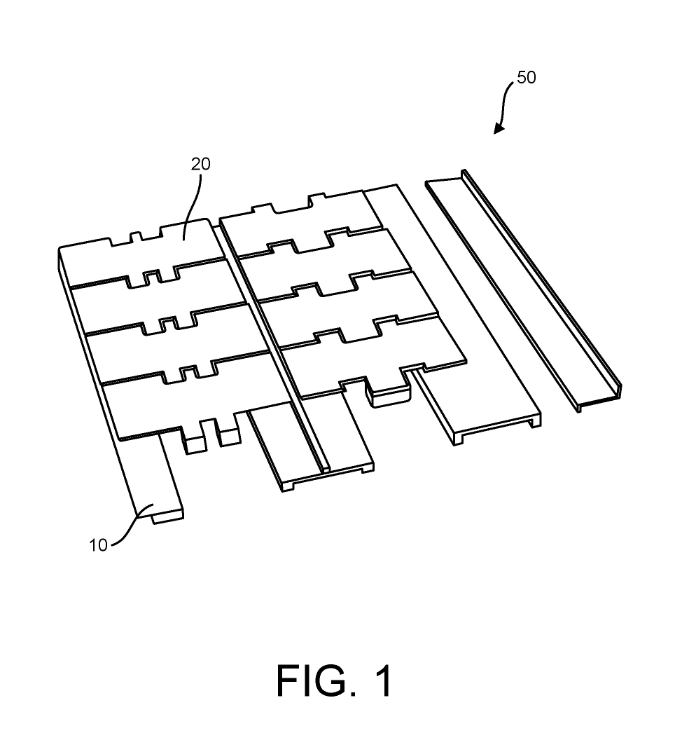

In particular, these properties can be utilized in industries requiring storage and conveying such as those requiring conveyor components. For instance, the polyethylene composition of the present disclosure may be utilized for conveyor parts in the glass bottling industry and, as shown in FIG. 1, may be utilized as a wear strip or guide 10 for a conveyor assembly 50. A wear strip or guide 10 is generally a material on which a conveyor chain 20 slides or moves. In one embodiment, the conveyor chain 20 may be comprised of a polyacetal such as a polyoxymethylene and the wear strip or guide 10 may be comprised of the composition of the present disclosure. For instance, as shown in FIG. 1, the wear strip or guide 10 provides a base or foundation upon which the polyacetal chain or chain links 20 glide or move. In certain embodiments, the chains or chain links 20 may glide at high speeds. When these chains are gliding or moving at high speeds, this may result in significant wear and or melting of one or both components. However, by utilizing the polyethylene composition of the present disclosure, when operating at higher speeds, wear and/or melting of one or both components in the conveying process may be minimized or even removed. As such, by using an polyethylene composition as described herein, conveying speeds may be increased compared to those allowed by prior polyethylene materials.

### Example

The examples are given below by way of illustration and not by way of limitation. The following experiments were conducted in order to show some of the benefits and advantages of the present invention.

Polymer compositions comprising a polyethylene polymer and a thermally conductive particulate filler were produced. The relative amount of each component of the composition is provided in Table 1.

Samples 1-9 were comprised of an ultrahigh molecular weight polyethylene polymer and at least one thermally conductive filler such as graphite particles, boron nitride particles, or aluminum particles. The boron nitride 1 particles had average particle size of less than about 20 μm. The boron nitride 2 particles had a particle size of greater than about 20 μm.

The components of each composition were mixed and heated to a temperature of from about 180 to 250° C. The composition was compression molded to prepare specimens for testing. Tests were then conducted on the specimens to determine the thermal properties.

The thermal diffusivity of each specimen was determined using the Laser Flash Method according to ASTM E1461. Thermal diffusivities were measured in the through-plane, flow, and cross-flow directions. The thermal conductivities were calculated using the relationship:

λ=α*Cₚ*ρ

where λ is thermal conductivity, α is thermal diffusivity, Cₚ is specific heat capacity, and ρ is the density of the molded article. The results are shown below in Table 2.

TABLE 1

| Sample Number | 1 | 2 | 3 | 4 | 5 | 6 | 7 | 8 | 9 |
|---|---|---|---|---|---|---|---|---|---|
| UHMW-PE (bulk | 60 | 90 | 80 | 90 | 80 | 60 | 90 | 80 | 80 |
| density ≤ 0.25 g/cm³) | | | | | | | | | |
| Graphite Particles | 10 | — | — | — | — | — | 10 | 20 | 20 |
| Aluminum Particles | 30 | — | — | — | — | — | — | — | — |
| Boron Nitride 1 Particles | — | 10 | 20 | — | — | — | — | — | — |
| Boron Nitride 2 Particles | — | — | — | 10 | 20 | 40 | — | — | — |

TABLE 2

| | | Through- | Through- | | | Cross- | Cross- |
|---|---|---|---|---|---|---|---|
| | Heat | plane | plane | Flow- | Flow | Flow | Flow |
| | Capacity | Diffusivity | Conductivity | Diffusivity | Conductivity | Diffusivity | Conductivity |
| Sample | [J/(gK)] | [mm²/s] | [W/(mK)] | [mm²/s] | [W/(mK)] | [mm²/s] | [W/(mK)] |
| 1 | 1.58 | 0.66 | 1.32 | 1.14 | 2.26 | 1.06 | 2.11 |
| 2 | 2.16 | 0.40 | 0.85 | 0.60 | 1.28 | 0.56 | 1.20 |
| 3 | 1.85 | 0.72 | 1.39 | 1.35 | 2.62 | 1.34 | 2.58 |
| 4 | 1.99 | 0.36 | 0.70 | 0.51 | 0.99 | 0.47 | 0.93 |
| 5 | 2.02 | 0.53 | 1.13 | 1.11 | 2.36 | 1.04 | 2.21 |
| 6 | 1.67 | 0.95 | 1.91 | 3.65 | 7.39 | 3.47 | 6.96 |
| 7 | 2.28 | 0.37 | 0.83 | 1.24 | 2.78 | 1.10 | 2.48 |
| 8 | 2.29 | 0.56 | 1.35 | 3.87 | 9.35 | 3.53 | 8.52 |
| 9 | 1.98 | 0.88 | 1.83 | 3.29 | 6.84 | 3.40 | 7.08 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A conductive polymer composition comprising:
polyethylene polymer particles blended with at least one conductive filler, the at least one conductive filler being present in the polymer composition in an amount sufficient for the polymer composition to have an in-plane thermal conductivity of about 2.3 W/m-K or greater.

2. A conductive polymer composition as defined in claim 1, wherein the at least one conductive filler is present in the polymer composition in an amount sufficient for the polymer composition to have an in-plane thermal conductivity of greater than about 2.5 W/m-K.

3. A conductive polymer composition as defined in claim 1, wherein the at least one conductive filler is present in the polymer composition in an amount sufficient for the polymer composition to have an in-plane thermal conductivity of greater than about 6 W/m-K.

4. A conductive polymer composition as defined in claim 1, wherein the at least one conductive filler is present in the polymer composition in an amount sufficient for the polymer composition to have an in-plane thermal conductivity of about 2.3 W/m-K or greater in one direction and to have an in-plane thermal conductivity of about 2.3 W/m-K or greater in a perpendicular direction.

5. A conductive polymer composition as defined in claim 1, wherein the at least one conductive filler is present in the polymer composition in an amount greater than about 5% by weight.

6. A conductive polymer composition as defined in claim 1, wherein the at least one conductive filler comprises boron nitride particles.

7. A conductive polymer composition as defined in claim 1, wherein the at least one conductive filler contained in the conductive polymer composition comprises graphite particles.

8. A conductive polymer composition as defined in claim 1, wherein the polyethylene polymer is a high molecular weight polyethylene.

9. A conductive polymer composition as defined in claim 1, wherein the polyethylene polymer has a bulk density of less than about 0.3 g/cm³.

10. A conductive polymer composition as defined in claim 1, wherein the polyethylene polymer has an average molecular weight of greater than about 1,000,000 g/mol.

11. A conductive polymer composition as defined in claim 1, wherein the at least one conductive filler is contained in the polymer composition in an amount from about 20% to about 40% by weight.

12. A conductive polymer composition as defined in claim 1, wherein the at least one conductive filler comprises particles having an average particle size 050) of from about 0.5 microns to about 50 microns.

13. A polymer article formed from the conductive polymer composition as defined in claim 1.

14. A polymer article as defined in claim 12, wherein the article comprises a wear strip or guide.

15. A polymer article as defined in claim 13, wherein the wear strip or guide is configured to support a conveyor.

16. A conductive polymer composition comprising:
polyethylene polymer particles blended with an ionic liquid.

17. A conductive polymer composition as defined in claim 16, wherein the polyethylene polymer particles have a bulk density of less than about 0.3 g/cm³.

18. A conductive polymer composition as defined in claim 16, wherein the polyethylene polymer particles have an average molecular weight of greater than about 1,000,000 g/mol.

19. A conductive polymer composition as defined in claim 16, wherein the ionic liquid is present in the polymer composition in an amount from about 1% to about 15% by weight.

20. A conductive polymer composition as defined in claim 16, wherein the polymer composition further contains a conductive filler.

21. A conductive polymer composition as defined in claim 20, wherein the conductive filler comprises boron nitride, graphite, or mixtures thereof, the conductive filler being present in an amount of from about 10% to about 40% by weight.

22. A conductive polymer composition comprising:
polyethylene polymer particles blended with at least one conductive filler, the at least one conductive filler being present in the polymer composition in an amount sufficient for the polymer composition to have an in-plane thermal conductivity of about 1 W/m-K or greater, the polyethylene being present in the polymer composition in an amount greater than about 65 wt. %.
